(19) United States
(12) Patent Application Publication
(10) Pub. No.: US 2010/0326450 A1
(43) Pub. Date: Dec. 30, 2010

(54) Cheek Saver

(75) Inventor: Narayanan M. Subramanian, Marietta, GA (US)

Correspondence Address: NARAYANAN M. SUBRAMANIAN, 4251 CREEK HAVEN DR., MARIETTA, GA, 30062, US

(73) Assignee: INVENTION DYNAMICS, LLC, Marietta, GA (US)

(21) Appl. No.: 12/826,190

(22) Filed: Jun. 29, 2010

Related U.S. Application Data
(60) Provisional application No. 61/222,055, filed on Jun. 30, 2009.

(51) Int. Cl. A61C 5/14

(52) U.S. Cl. 128/859

(57) ABSTRACT

Two substantially rectangular, thin, flexible plates, connected by a third substantially narrow, rectangular, thin, flexible plate, together forming the preferred embodiment, is placed between the cheeks and the jaws to prevent the molars biting into the cheeks and the front incisors biting into the lip.

### REFERENCE CITED

U.S. Pat. No. 7,422,017—Sep. 9, 2008—Bancroft; James—Mouthguard

U.S. Pat. No. 6,681,771—Jan. 27, 2004—Durette; Jean-Francois—organ shields for medical procedure

U.S. Pat. No. 6,269,816—Aug. 7, 2001—Rigonatti; Sergio, Napole; Rita de Cassia D'Ottaviano—Buccal protector

U.S. Pat. No. 5,732,715—Mar. 31, 1998—Jacobs; Scott, Jacobs; Allison J.—Mouthpiece

U.S. Pat. No. 5,692,523—Dec. 2, 1997—Croll et al.—two-piece mouthguard

U.S. Pat. No. 5,636,379—Jun. 10, 1997—Williams; Edward D.—jaw-joint protective device

U.S. Pat. No. 5,533,523—Jul. 9, 1996—Bass, Jr; Robert, Barsamian; James G—Medical mouthpiece

U.S. Pat. No. 5,447,168—Sep. 5, 1995—Bancroft; James—mouthguard

U.S. Pat. No. 4,502,478—Mar. 5, 1985—Medical instrument mouth guard

U.S. Pat. No. 4,495,945—Liegner; Kenneth B.—bite block

### PRIORITY CLAIM

This patent application claims priority from provisional U.S. patent application entitled “Cheek Saver,” having application Ser. No. 61/222,055 filed on Jun. 30, 2009, the contents of which are incorporated herein by reference.

### FIELD OF INVENTION

The present invention relates to protecting the cheek and lower lip from being bitten especially when the cheeks and lips are numb from exposure to cold or from the effects of anesthesia during a dental procedure.

### BACKGROUND OF INVENTION

When a dental procedure such as root canal or cavity filling is done, the dentist initially administers a local anesthesia to numb the area where the procedure is to be performed. Sufficient anesthesia is administered such that the numbness lasts for a few hours after the procedure is complete. The numbness is felt in the cheeks. Depending on the tooth involved, the lower lips can also get numb. During this period, if the person moves his jaws, he can inadvertently bite his cheek or lower lip without feeling it. After the numbness is fully gone, he realizes that he had bitten his cheeks and/or lower lip when the anesthesia was in effect. This also happens when the person has some food to eat before the numbness is fully gone or when the cheek is swollen such that the cheek tissue protrudes in the way of the teeth during jaw movement.

Though quite a few patents have been issued for mouth guards as revealed in the references cited above, they are specifically designed for contact sport to protect the teeth when the opponent hits them in the jaw while playing. They do not address the need for protecting the cheeks while still be able to talk or eat. So there is a need for such a device in the market.

### SUMMARY OF INVENTION

The primary objective of the present invention is to come up with a cheek and lip protector apparatus that is easy to wear and comfortable in the mouth.

Another objective of the present invention is to make the protector such that the wearer can talk or eat without worrying about biting the cheek or lower lip.

The foregoing objectives are attained by having a thing, flexible, narrow rectangular plate connected on both narrow ends to two much larger oval or rectangular, thin, flexible plates. The dimensions of the much larger oval or rectangular plates are such that the device will fit comfortably between the jaws and cheek. The narrow rectangular connecting plate has a notch in the center that fits snugly between the lower jaw and the lower lip.

In this respect, before explaining at least one embodiment of the invention in detail, it is to be understood that the invention is not limited in its application to the details of construction and to the arrangements of the components set forth in the following description or illustrated in the drawing(s). The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of the preferred embodiment of the cheek saver. It consists of two substantially thin, flexible rectangular plates with rounded corners that are connected by a third rectangular plate that is longer and narrower than the said two rectangular plates it connects.

FIG. 2 is a perspective view of the cheek saver placed in the space between the jaws and the cheek-lower lip continuum.

### DETAILED DESCRIPTION OF THE INVENTION

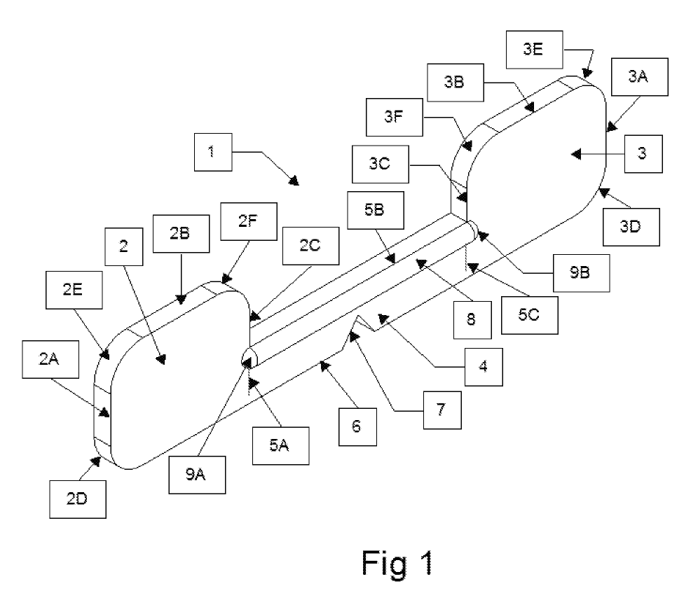

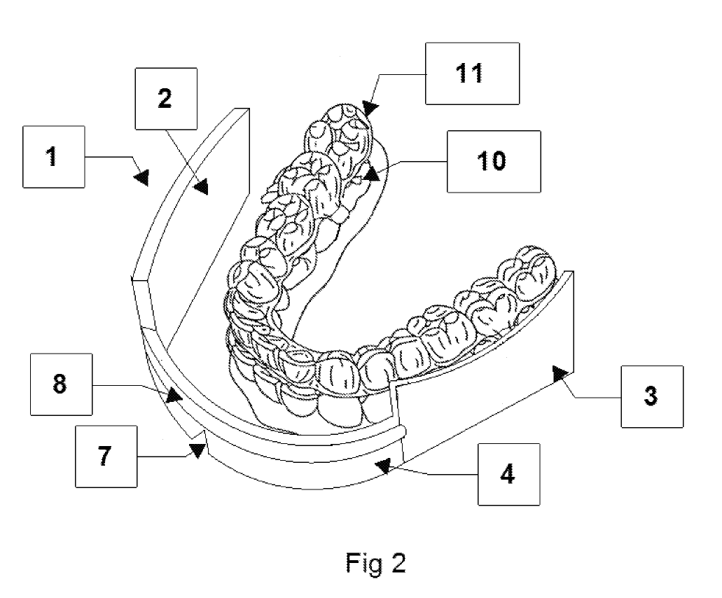

FIG. 1 refers to a preferred embodiment of the present invention. Here, the cheek saver unit is generally referred to as 1. Unit 1 consists of two substantially rectangular, thin, flexible plates, 2 and 3, integrally connected by a third substantially rectangular, narrow, thin, flexible plate, 4. Plates 2 and 3 are substantially equal in length and width. Plate 2 and plate 3, each have a first long side, a second long side parallel to said first long side, a first short side perpendicular to said first long side and a second short side parallel to said first short side. For plate 2, the first short side is marked 2A, second long side is marked 2B and second short side is marked 2C. For plate 3, the first short side is marked 3A, second long side is marked 3B and second short side is marked 3C. Plate 4 has a first long side and a second long side. The second long side is marked 5B. It also has a first short side and a second short side when sectioned. Plate 4 is substantially longer and narrower than plates 2 and 3. Plates 2, 4, and 3 together form one contiguous unit, referred to here as unit 1. The first long side of plate 2, the first long side of plate 4 and the first long side of plate 3 together form one contiguous side marked 6. For illustrative purposes, dotted line 5A is shown where the first short side of plate 4 merges with side 2C. Similarly, dotted line 5C is shown where the second short side of plate 4 merges with side 3C. To further separate the lower lip from the front incisors of the upper jaw, a flexible, semi-circular bar, 8, is attached to plate 4 such that the longitudinal extent of 8 is substantially parallel to the second long side, 5B, of plate 4. The free ends of 8 are rounded out and are marked as 9A and 9B. Each part, 9A and 9B, is a quarter of a sphere with a diameter equal to the diameter of the semi circular bar, 8. Since the lower lip is attached to the lower jaw in the front of the mouth at the center by a connecting tissue, to bridge over this connecting tissue, a notch, in the shape of an inverted ‘V’, numbered 7, is cut along the first long side of plate 4. FIG. 2 shows the preferred embodiment of the cheek saver placed around the upper and lower jaws.

To avoid sharp edges that can bruise the cheeks or gum, the corners of plate 2 are rounded as indicated by 2D, 2E and 2F. The length of first long side of plate 2 is such that when the first short side, 2A, is substantially in touch with the cheek and jaw joint at the back of the mouth, the second short side, 2C, is close to the canine teeth that are closest to side 2A. For unit 1 to be comfortable in use but still be effective in preventing the teeth from biting into the cheeks, the width, 2A of plate 2 should be slightly less than the distance from the lower jaw-cheek joint at the bottom of the mouth to the upper jaw-cheek joint at the top of the mouth. In order for the unit to stay in place and protect the cheek from the molars while eating or talking, the width, 2A, of the unit should be such that, when the first long side, 6, rests where the cheek meets the lower jaw at the bottom of the mouth, the upper jaw molars are below the level of second long side 2B. Similarly, plate 3, which has substantially the same shape and size as plate 2, protects the other cheek.

When the molars of the upper jaw are resting on the molars of the lower jaw, the front incisors of the upper jaw partially cover over the front incisors of the lower jaw. Hence only the lower lip can get caught between the front incisors of the upper and lower jaws. Plate 4 prevents this from happening. The length of the second long side, 5B, of plate 4, which is the distance between 2C of plate 2 and 3C of plate 3, is such that when 2C is near the right canine teeth of the mouth, 3C is near the left canine teeth of the mouth. The width of plate 4, which is the distance between 5B and 6, is such that when worn, side 5B reaches up to the bottom of the front incisors of the upper jaw when the jaws are closed.

Thus, as can be seen from the above description, unit 1 acts as a barrier wall between the cheeks and the molars, preventing the cheek tissue from getting caught between the molars. It also acts as a barrier wall between the lower lip and the front incisors, thus protecting the lower lip. Since the material is flexible, it will not hurt the mouth when the jaws are moved as when talking or eating.

FIG. 2 shows the cheek saver placement. Here unit 1 is placed such that plate 2 is between the right cheek and the jaws, plate 4 is between the lower lip and the lower front incisors and plate 3 is between the left cheek and the jaws. The upper jaw teeth are denoted as 11 while the lower jaw teeth are denoted as 10.

After the dental procedure is complete at the dentist office, the dentist or the patient can slip the cheek saver unit 1 in the mouth as described above. This protects the cheeks and lips from being bitten when the cheeks and/or lips are still numb. The patient can talk, drink or even eat when the numbness is not completely gone.

What is claimed is:

1. A cheek saver comprising of two substantially thin, flexible cheek guard plates connected by a third substantially thin, flexible, connecting plate.

2. A cheek saver of claim 1 wherein said cheek guard plates and said connecting plate are substantially the same thickness.

3. A cheek saver of claim 2 wherein said cheek guard plates and said connecting plate are substantially in the same plane.

4. A cheek saver of claim 3 wherein said cheek guard plates are substantially the same size.

5. A cheek saver of claim 4 wherein said cheek guard plates do not have sharp vertices.

6. A cheek saver of claim 5 wherein said cheek guard plates are at the most as wide as the distance from the lower jaw-cheek tissue joint on the bottom of the mouth to the upper jaw-cheek tissue joint at the top of the mouth when the jaws are closed.

7. A cheek saver of claim 3 wherein said connecting plate is substantially rectangular in shape having a first long side, a second long side, a first short side and a second short side.

8. A cheek saver of claim 7 wherein said connecting plate has a length equal to the linear distance between the two canine teeth in the lower jaw.

9. A cheek saver of claim 8 wherein said connecting plate has a notch that is substantially equidistant from said two cheek guard plates.

10. A cheek saver of claim 9 wherein said notch is an inverted ‘V’.

11. A cheek saver of claim 10 wherein the free ends of said notch are substantially in line with said first long side of said connecting plate.

12. A cheek saver of claim 8 wherein said connecting plate has a substantially flexible bar on said second long side.

13. A cheek saver of claim 12 wherein said flexible bar has rounded edges.

14. A cheek saver of claim 8 wherein said first short side and said second short side of said connecting plate are substantially wide enough to cover lower incisors of lower jaw exposed below upper incisors of upper jaw.

15. A cheek saver of claim 6 wherein said cheek guard plates are substantially rectangular in shape, each cheek guard plate having a first long side, a second long side, a first short side and a second short side.

16. A cheek saver of claim 15 wherein said second long sides of said cheek guard plates are at least as long as the linear distance from the canine teeth to the molars farthest from said canine teeth on the same side of the mouth.

17. A cheek saver of claim 15 wherein said first long side of said connecting plate is substantially in the same line as the first long side of each of said two cheek guard plates.

18. A cheek saver of claim 6 wherein said cheek guard plates are substantially oval in shape with a major axis and a minor axis.
